(19) United States
(12) Patent Application Publication
(10) Pub. No.: US 2017/0036648 A1
(43) Pub. Date: Feb. 9, 2017

(54) WINDOW WIPER MECHANISM

(71) Applicant: DONGGUAN HONGYI WIPER CO., LTD., Dong Guan City (CN)

(72) Inventor: YUAN-CHIN KU, NEW TAIPEI CITY (TW)

(21) Appl. No.: 14/820,606

(22) Filed: Aug. 7, 2015

(51) Int. Cl. B60S 1/38; B60S 1/42

(52) U.S. Cl. CPC B60S 1/3801; B60S 1/42

(57) ABSTRACT

A window wiper mechanism includes a base member, a wiper member, and an accessory member. The base member includes an accommodating groove which has an abutting surface and an engaging portion. The abutting surface and the engaging portion are disposed corresponding to each other. The wiper member is disposed on the base member. The accessory member is disposed in the accommodating groove and has an abutting portion and a fastening portion. The abutting portion abuts against the abutting surface of the base member, and the engaging portion and the fastening portion are connected with each other.

### BACKGROUND OF THE INVENTION

1. Field of the Invention

The present invention relates to a window wiper mechanism; in particular, to a window wiper mechanism that is easy to take apart, is difficult to damage, and is adapted for different models of cars.

2. Description of Related Art

A window wiper is disposed at the front and rear windows of a car for wiping rain or sludge attached on the windows, so as to avoid a driver's sight from being disturbed and to avoid accidents.

The window wiper of the prior art includes a supporting member, a base member, an accessory member, a wiper member, and an auxiliary support frame. The base member is fixed at the middle of the supporting member having a top surface, the wiper member is fixed at the supporting member having a bottom surface, the accessory member is engaged to the base member, and the auxiliary support frame is disposed at a bottom of the base member to provide a supporting force for support between the base member and the accessory member. The window wiper can be set on a wiper arm of the car using the accessory member, so as to use the wiper arm to bring the window wiper to move, and the wiper member wipes the rain or sludge attached on the windows.

However, the accessory member and the base member of the abovementioned window wiper of the prior art have to be disposed with complex configurations therebetween, such as a pressing member needing to be disposed for controlling movement of an engaging configuration which is hard to operate, so as to cause the accessory member and the base member being difficult to take apart.

Therefore, the inventor of the present invention provides a window wiper mechanism which is designed ideally for overcoming the above said drawbacks.

### SUMMARY OF THE INVENTION

In order to overcome the abovementioned drawbacks, the present invention provides a window wiper mechanism, via connection between an accessory member and a base member disposed on the window wiper mechanism, a user can quickly change various accessory members to dispose the window wiper mechanism stably on the different models of cars.

In order to achieve the above said purposes, one of embodiments in the present invention provides a window wiper mechanism which includes a base member, a wiper member, and an accessory member. The base member includes an accommodating groove which has an abutting surface and an engaging portion. The abutting surface and the engaging portion are disposed corresponding to each other. The wiper member is disposed on the base member. The accessory member is disposed in the accommodating groove and has an abutting portion and a fastening portion. The abutting portion abuts against the abutting surface of the base member, and the engaging portion and the fastening portion are connected with each other.

The present invention has the benefit that, the window wiper mechanism of the embodiment in the present invention provides a quick and convenient way for the user to change the window wiper mechanism which is adapted for different models of cars, via the connection between the accessory member and the base member disposed.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1A shows one of perspective schematic views of a window wiper mechanism in assembled state of a first embodiment of the present invention;

FIG. 1B shows another of the perspective schematic views of the window wiper mechanism in assembled state of the first embodiment of the present invention;

FIG. 1C shows one of the perspective schematic views of the window wiper mechanism in exploded state of the first embodiment of the present invention;

FIG. 1D shows another of the perspective schematic views of the window wiper mechanism in exploded state of the first embodiment of the present invention;

FIG. 2A shows the perspective schematic view (1) of an accessory member and a base member in exploded state of the first embodiment of the present invention;

FIG. 2B shows the perspective schematic view (2) of the accessory member and the base member in exploded state of the first embodiment of the present invention;

FIG. 2C shows the perspective schematic view (3) of the accessory member and the base member in exploded state of the first embodiment of the present invention;

FIG. 2D shows the perspective schematic view (4) of the accessory member and the base member in exploded state of the first embodiment of the present invention;

FIG. 3A shows the perspective schematic views of the window wiper mechanism in assembled state of a second embodiment of the present invention;

FIG. 3B shows the perspective schematic views of the window wiper mechanism in exploded state of the second embodiment of the present invention;

FIG. 3C shows one of the perspective schematic views of the accessory member and the base member in exploded state of the second embodiment of the present invention;

FIG. 3D shows another of the perspective schematic views of the accessory member and the base member in exploded state of the second embodiment of the present invention;

FIG. 4A is the perspective schematic view of the accessory member of a third embodiment of the present invention;

FIG. 4B is the perspective schematic view of the accessory member of a fourth embodiment of the present invention; and

FIG. 4C is the perspective schematic view of the accessory member of a fifth embodiment of the present invention.

### DETAILED DESCRIPTION OF THE PREFERRED EMBODIMENTS

Embodiments of the window wiper mechanism disclosed in the present invention are illustrated via specific examples as follows, and persons familiar in the art may easily understand other advantages and efficacies of the present invention by the disclosure of the specification. The present invention may be implemented or applied by other different specific examples, and each of the details in the specification may be applied based on different views and may be modified and changed keeping the spirit of the present invention. The figures in the present invention are only for brief description, but they are not depicted according to actual size and do not reflect the actual size of the relevant configuration. The following embodiments further illustrate related technologies of the present invention in detail, but scope of the present invention are not limited herein.

### First Embodiment

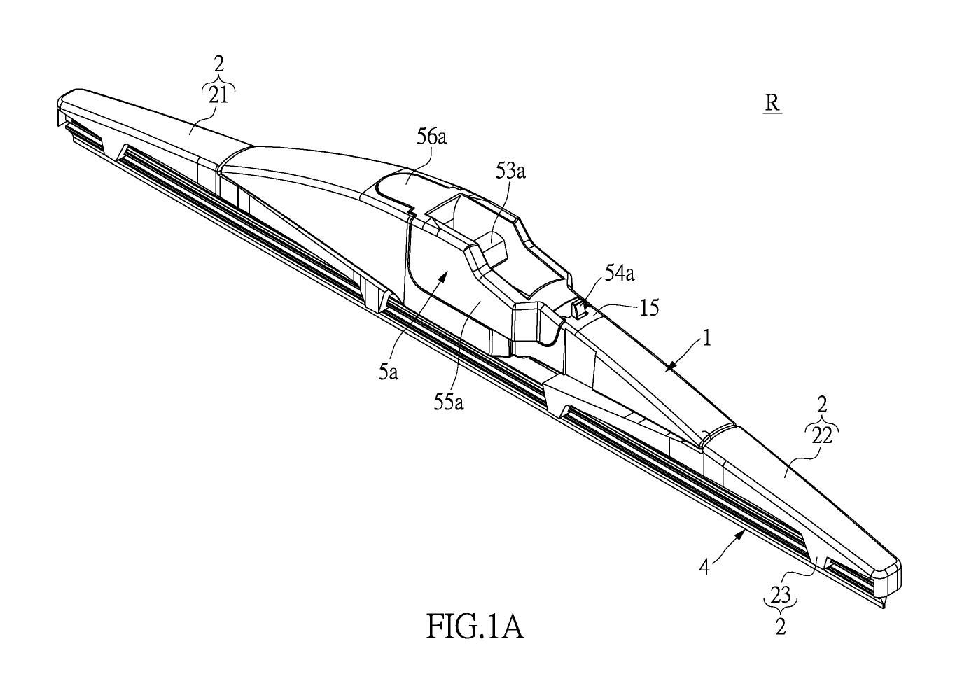

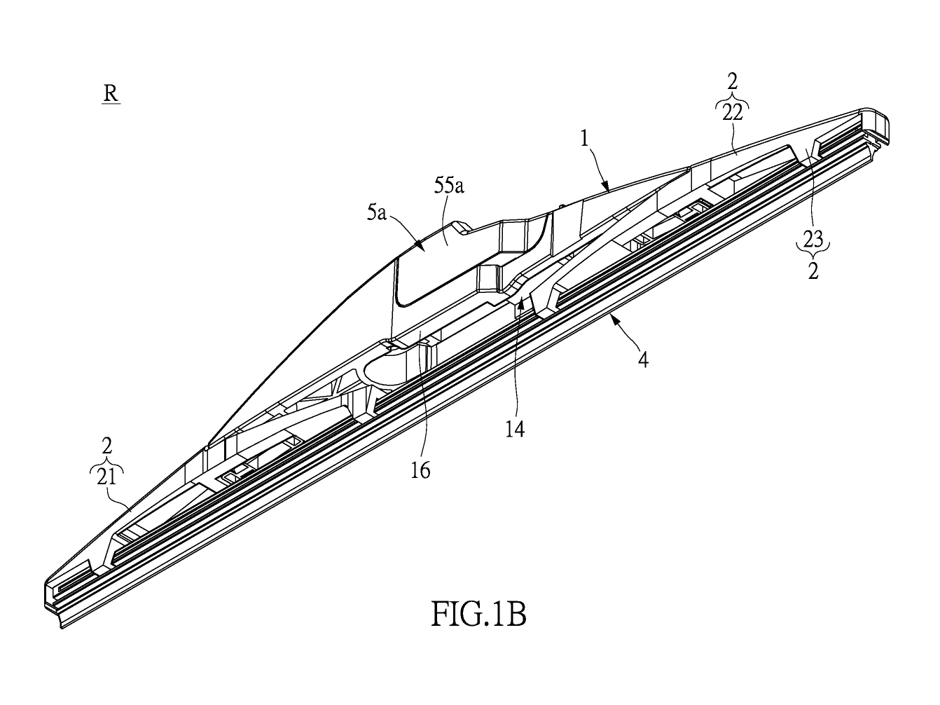

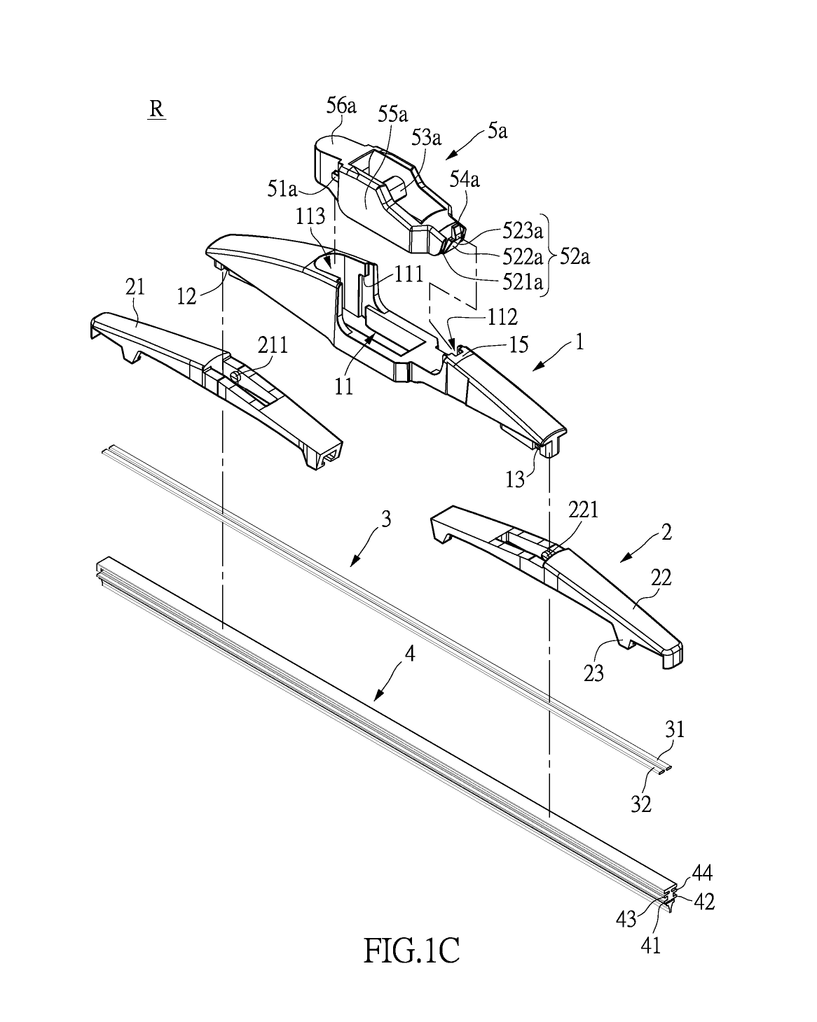

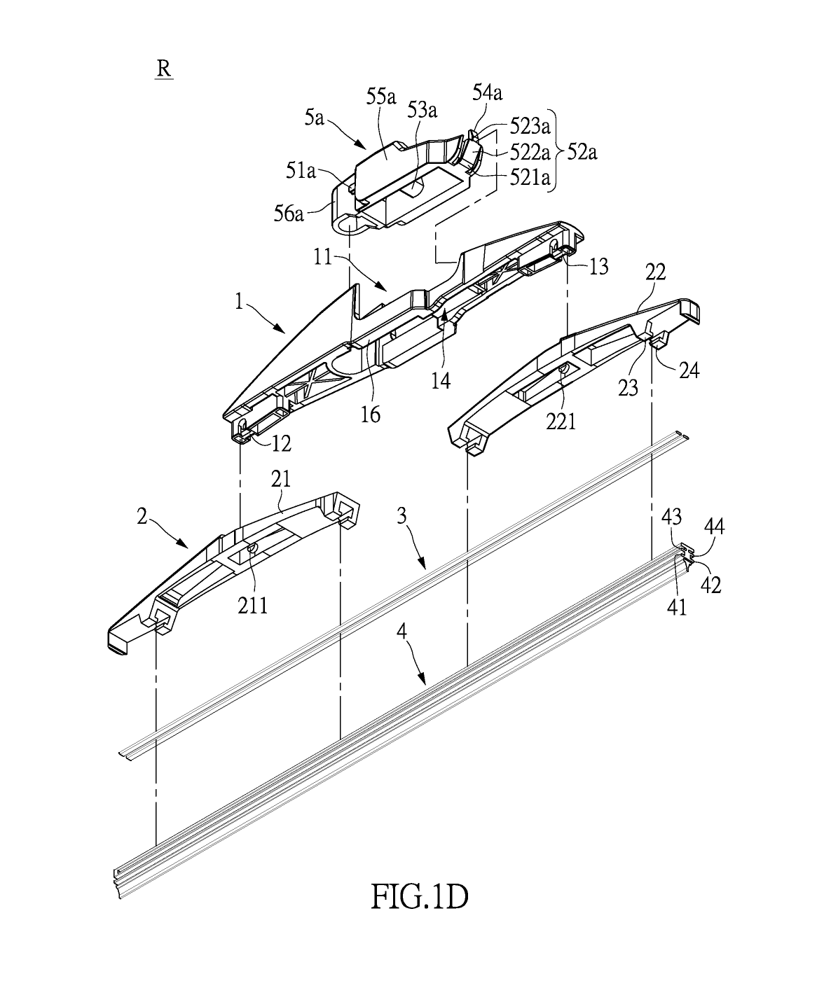

Firstly, referring to FIGS. 1A to 1D, FIG. 1A shows one of the perspective schematic views of a window wiper mechanism in assembled state of a first embodiment of the present invention. FIG. 1B shows another of the perspective schematic views of the window wiper mechanism in assembled state of the first embodiment of the present invention. FIG. 1C shows one of the perspective schematic views of the window wiper mechanism in exploded state of the first embodiment of the present invention. FIG. 1D shows another of the perspective schematic views of the window wiper mechanism in exploded state of the first embodiment of the present invention. The first embodiment of the present invention provides a window wiper mechanism which includes a base member 1, a standing member 2, a supporting member 3, a wiper member 4, and an accessory member 5.

Specifically, the base member 1 includes an accommodating groove 11, a first connecting part 12, and a second connecting part 13. The accommodating groove 11 is disposed between the first connecting part 12 and the second connecting part 13, but it is not limited herein. Then, the standing member 2 may be disposed on the base member 1, and includes a first standing part 21 and a second standing part 22. The first standing part 21 and the second standing part 22 are disposed corresponding to each other, but it is not limited herein. For example, the first standing part 21 and the second standing part 22 may be disposed at opposite sides of the base member 1, respectively. In addition, the first standing part 21 and the second standing part 22 may be formed into one piece to be one standing member 2. But, the configuration of the standing member 2 is substantially identical to that of prior art, and specific configuration of the standing member 2 is not limited in the present invention, so it does not bear repeating herein.

Next, the first standing part 21 has a first bonding part 211, the second standing part 22 has a second bonding part 221, the first bonding part 211 and the first connecting part 12 of the base member 1 are connected with each other, and the second bonding part 221 and the second connecting part 13 of the base member 1 are connected with each other. Examples of connecting ways of the first bonding part 211 and the first connecting part 12, and the second bonding part 221 and the second connecting part 13 include, but are not limited to, latching and screwing. The connecting ways of the standing member 2 and the base member 1 are substantially identical to that of prior art, and the connecting way of the standing member 2 and the base member 1 is not limited in the present invention, so it does not bear repeating herein.

According to the above, the wiper member 4 may be disposed on the base member 1, or may be combined via the abovementioned components. For example, the supporting member 3 may be disposed on the standing member 2, and the wiper member 4 may be disposed on the supporting member 3, wherein the wiper member 4 may be connected to the standing member 2 through the supporting member 3. In addition, the wiper member 4 may be disposed on the base member 1 through the standing member 2. For example, the standing member 2 may have a first clamping end 23 and a second clamping end 24, the wiper member 4 may have a first groove portion 41 and a second groove portion 42, and the first groove portion 41 and the second groove portion 42 are respectively disposed at two opposite sides of the wiper member 4 via the first clamping end 23 engaging to the first groove portion 41 and the second clamping end 24 engaging to the second groove portion 42, so that the standing member 2 and the wiper member 4 are connected with each other. Then, the supporting member 3 includes a first supporting portion 31 and a second supporting portion 32, the wiper member 4 has a third groove portion 43 and a fourth groove portion 44, the third groove portion 43 and the fourth groove portion 44 are respectively disposed at two opposite sides of the wiper member 4, the first supporting portion 31 is disposed in the third groove portion 43, and the second supporting portion 32 is disposed in the fourth groove portion 44. In this way, since the wiper member 4 has softer material, the third and fourth groove portions 43 and 44 may be added extra support thereon by the first supporting portion 31 and the second supporting portion 32. Additionally, in the embodiment of the present invention, the first supporting portion 31 and the second supporting portion 32 are elongated elastic steels, and they can be bended to form an arc shape. The wiper member 4 can be bonded on a windshield by the bendable elastic steel.

It is worth mentioning that, the wiper member 4 may be an elongated rubber, the first groove portion 41, the second groove portion 42, the third groove portion 43, and the fourth groove portion 44 disposed at the wiper member 4 have a wiper part therebeneath. The wiper part is a substantially triangular strip and wipes rain or sludge on the windshield. Configurations of the abovementioned supporting member 3 and the abovementioned wiper member 4 are substantially identical to that of prior art, and the specific configurations of the supporting member 3 and the wiper member 4 are not limited in the present invention, so they do not bear repeating herein. In addition, the first standing part 21 and the second standing part 22 may use wind drag generated by a car while it is traveling, and the wind drag having a force may be used to press the standing member 2 and the wiper member 4, so as to increase wiping effect (e.g., rain and sludge) of the wiper part of the wiper member 4. Furthermore, the base member 1 further includes a dodge groove 14, the dodge groove 14 and the accommodating groove 11 are disposed corresponding to each other, and the dodge groove 14 and the accommodating groove 11 are disposed at two sides of the base member 1 respectively, wherein the dodge groove 14 has a width larger than the wiper member 4 so as to receive the wiper member 4. Specifically, when the base member 1 suffers a pressure to lower its height, the wiper member 4 can be received in the dodge groove 14, so as to increase a curvature of the wiper member 4.

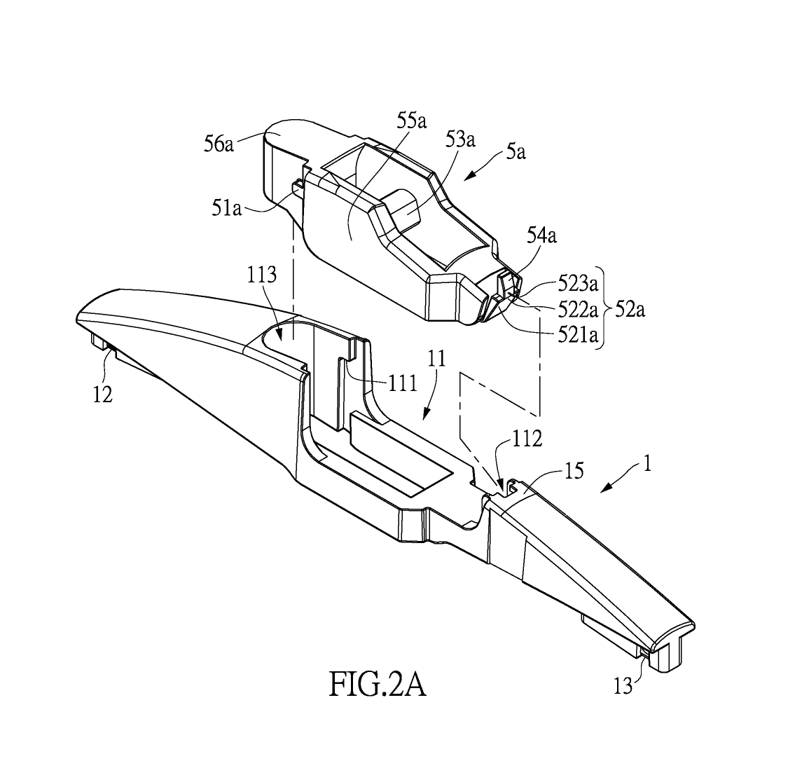

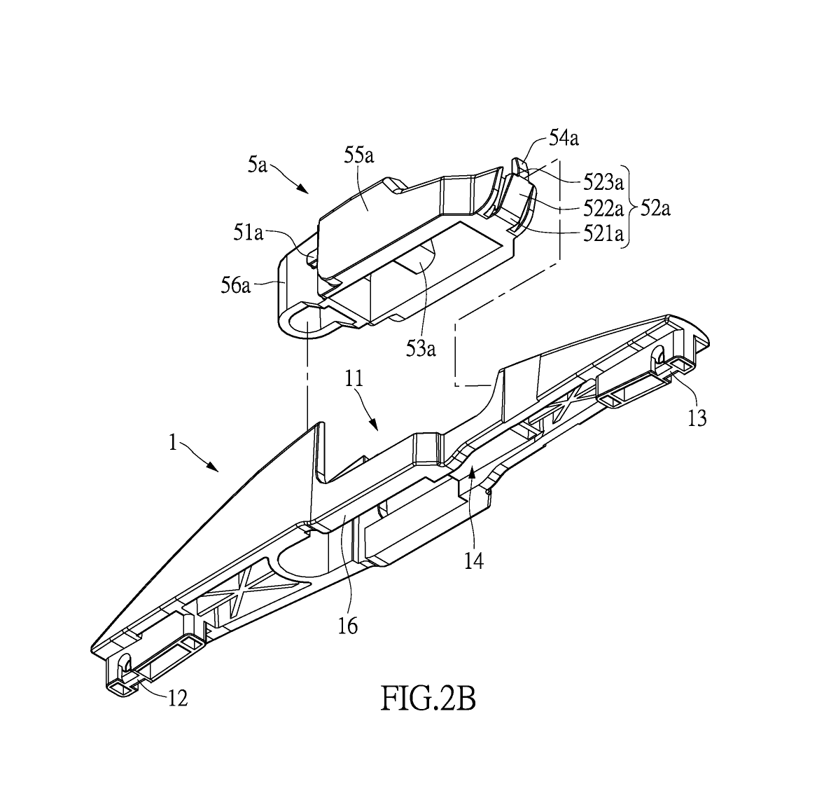

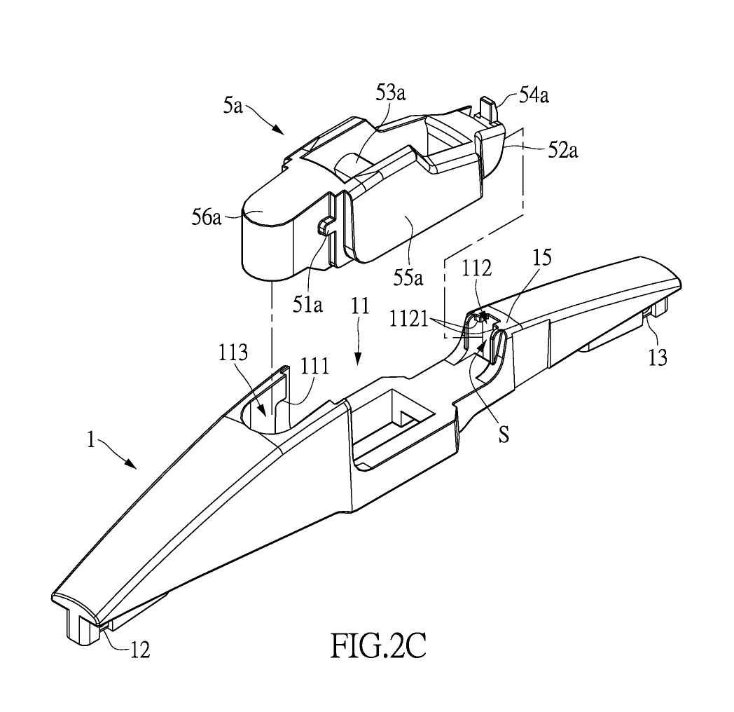

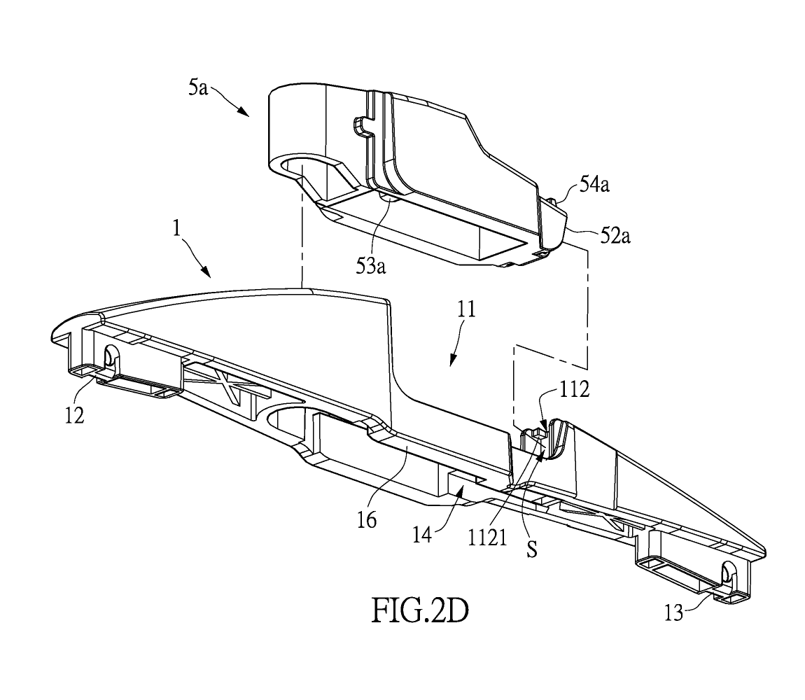

According to the above, the accessory member 5a is disposed in the accommodating groove 11 of the base member 1, the accessory member 5a has an abutting portion 51a and a fastening portion 52a, the abutting portion 51a abuts against the abutting surface 111 of the base member 1, and the engaging portion 112 and the fastening portion 52a are connected with each other. It should be stated that, in the first embodiment of the present invention, the accessory member 5a has two abutting portions 51a which are at symmetrical positions to respectively abut to the two abutting surfaces 111 of the base member 1. In detail, please refer to FIGS. 2A to 2D. FIG. 2A shows the perspective schematic view (1) of an accessory member and a base member in exploded state of the first embodiment of the present invention, FIG. 2B shows the perspective schematic view (2) of the accessory member and the base member in exploded state of the first embodiment of the present invention, FIG. 2C shows the perspective schematic view (3) of the accessory member and the base member in exploded state of the first embodiment of the present invention, and FIG. 2D shows the perspective schematic view (4) of the accessory member and the base member in exploded state of the first embodiment of the present invention. Specifically, the accommodating groove 11 of the base member 1 has an abutting surface 111 and an engaging portion 112, and the abutting surface 111 and the engaging portion 112 are disposed corresponding to each other. The engaging portion 112 has a clasping end 1121 and an accommodating space S corresponding to the fastening portion 52a of the accessory member 5a. In addition, the fastening portion 52a of the accessory member 5a has a bending end 521a, an inclined plane 522a, and a snap end 523a, and they abut against each other via the snap end 523a and the clasping end 1121 of the accommodating groove 11, such that the fastening portion 52a of the accessory member 5a and the engaging portion 112 of the base member 1 are connected with each other.

Accordingly, a user who would like to dispose the accessory member 5a on the base member 1 can insert sloping obliquely and buckle backward the accessory member 5a on the base member 1. For example, the accessory member 5a may be tilted with an angle of 15 degrees and the abutting portion 51a of the accessory member 5a may be abutted against the abutting surface 111 of the base member 1, the abutting portion 51a of the accessory member 5a is used as a pivot shaft, and one end of the abutting portion 51a opposite to the accessory member 5a is then pressed into the accommodating groove 11 of the base member 1, so that the accessory member 5a and the base member 1 are engaged with each other. Specifically, in the embodiment of the present invention, the bending end 521a may have an elastic force, hence, when the accessory member 5a is pressed into the accommodating groove 11 of the base member 1, the inclined plane 522a of the accessory member 5a slides into the accommodating space S of the base member 1 by the elastic force of the bending end 521a. When the inclined plane 522a of the accessory member 5a and the bending end 521a both slide into the accommodating space S of the base member 1, the snap end 523a of the accessory member 5a abuts against the clasping end 1121 of the base member 1. Therefore, the accessory member 5a is stably disposed in the accommodating groove 11 of the base member 1.

Then, the accessory member 5a further includes an end portion 54a which is disposed on the snap end 523a. Additionally, the base member 1 further includes an outer surface 15, and the end portion 54a is protruded on the outer surface 15. Specifically, in the embodiment of the present invention, the bending end 521a, the inclined plane 522a, the snap end 523a, and the end portion 54a are formed into one piece, and the end portion 54a is disposed between the two corresponding snap ends 523a. In this way, the bending end 521a, the inclined plane 522a, and the snap end 523a are moved by pressing the end portion 54a. In detail, when the user would like to remove the accessory member 5a from the base member 1, the user can press the end portion 54a of the accessory member 5a, so that the end portion 54a is moved toward to the abutting portion 51a. Thus, the bending end 521a, the inclined plane 522a, and the snap end 523a are moved away from the accommodating space S of the base member 1 by movement of the end portion 54a, and the snap end 523a of the accessory member 5a and the clasping end 1121 of the base member 1 are separated. It is worth mentioning that, the base member 1 further includes a bottom surface 16 which is located beneath the base member 1, and a vertical distance between the bottom surface 16 and the abutting surface 111 is larger than a vertical distance between the bottom surface 16 and the abutting portion 51a.

Furthermore, the accessory member 5a has a connecting portion 53a which is disposed between the abutting portion 51a and the fastening portion 52a, and is located between the accessory member 5a having two corresponding side walls 55a. Hence, a wiper arm of a car is fastened on the connecting portion 53a of the accessory member 5a. Due to the configuration of the accessory member 5a being mounted on the wiper arm of the car is prior art, and the configuration of the connecting portion 53a of the accessory member 5a being mounted on the wiper arm of the car is not limited in the present invention, it does not bear repeating herein.

As above, the accommodating groove 11 on the base member 1 further has an accommodating portion 113, the accessory member 5a further has a protruding portion 56a, and a shape of the accommodating portion 113 can correspond to the protruding portion 56a. Specifically, the protruding portion 56a is disposed between the two abutting portions 51a of the accessory member 5a. In this way, when the user abuts the abutting portion 51a of the accessory member 5a against the abutting surface 111 of the base member 1, the protruding portion 56a of the accessory member 5a is also abutted in the accommodating portion 113 of the base member 1, and the protruding portion 56a is disposed in the accommodating portion 113. Therefore, via the protruding portion 56a and the accommodating portion 113 abutting against each other, a bonding force between the accessory member 5a and the base member 1 is further increased.

The window wiper mechanism R of the first embodiment of the present invention can cooperate with the engaging portion 112 of the base member 1 via the fastening portion 52a of the accessory member 5a, such that the user can change various patterns of the accessory members 5a quickly. Accordingly, when the user presses the end portion 54a of the accessory members 5a, the end portion 54a is moved toward the abutting portion 51a, and the bending end 521a, the inclined plane 522a, and the snap end 523a are moved away from the accommodating space S of the base member 1 by movement of the end portion 54a. In such a way, the snap end 523a of the accessory member 5a and the clasping end 1121 of the base member 1 are separated.

### Second Embodiment

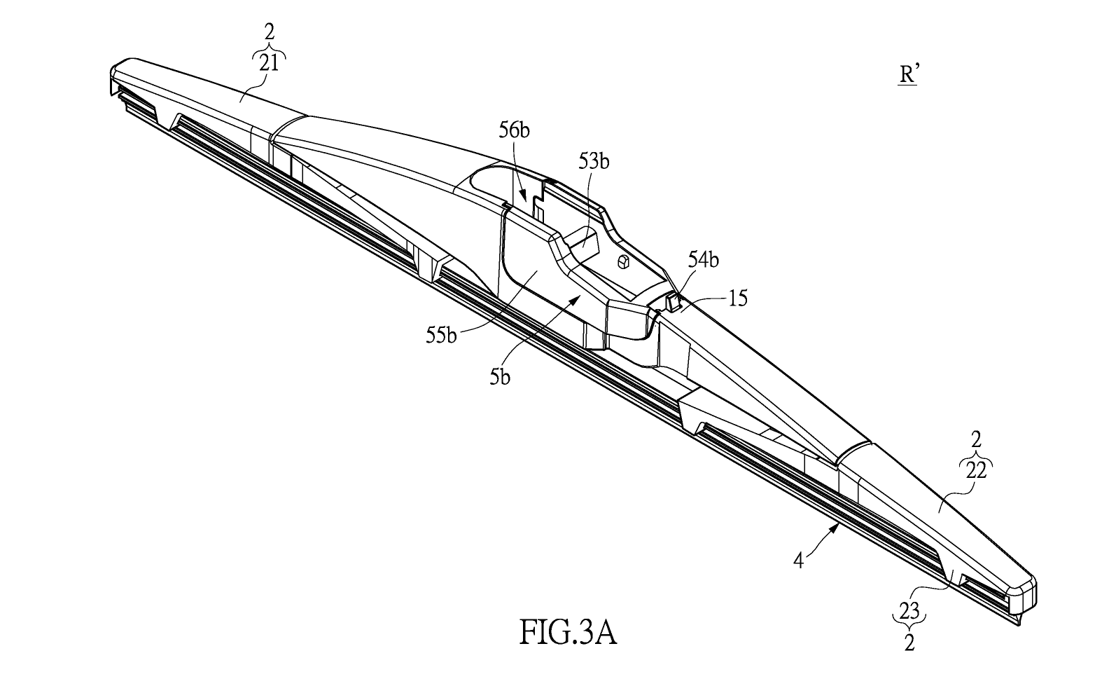

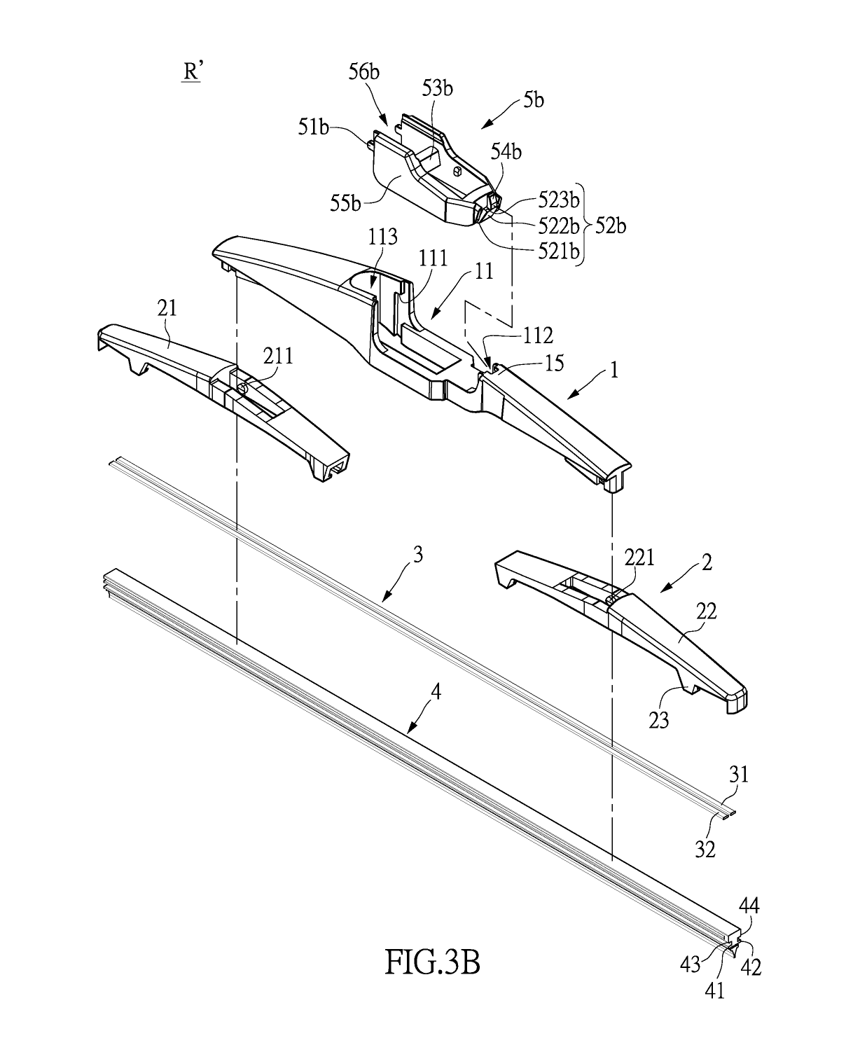

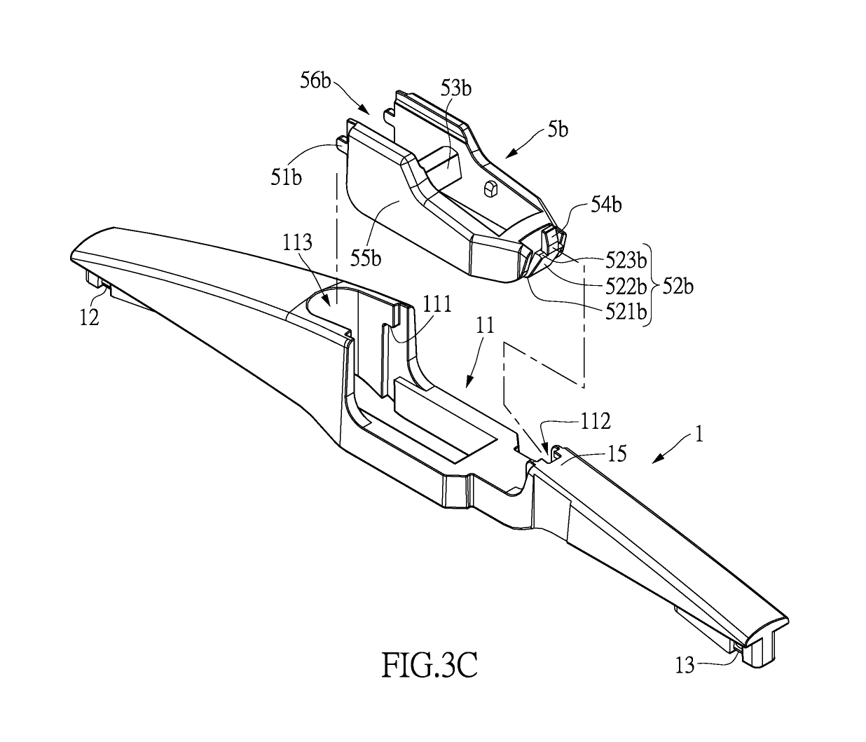

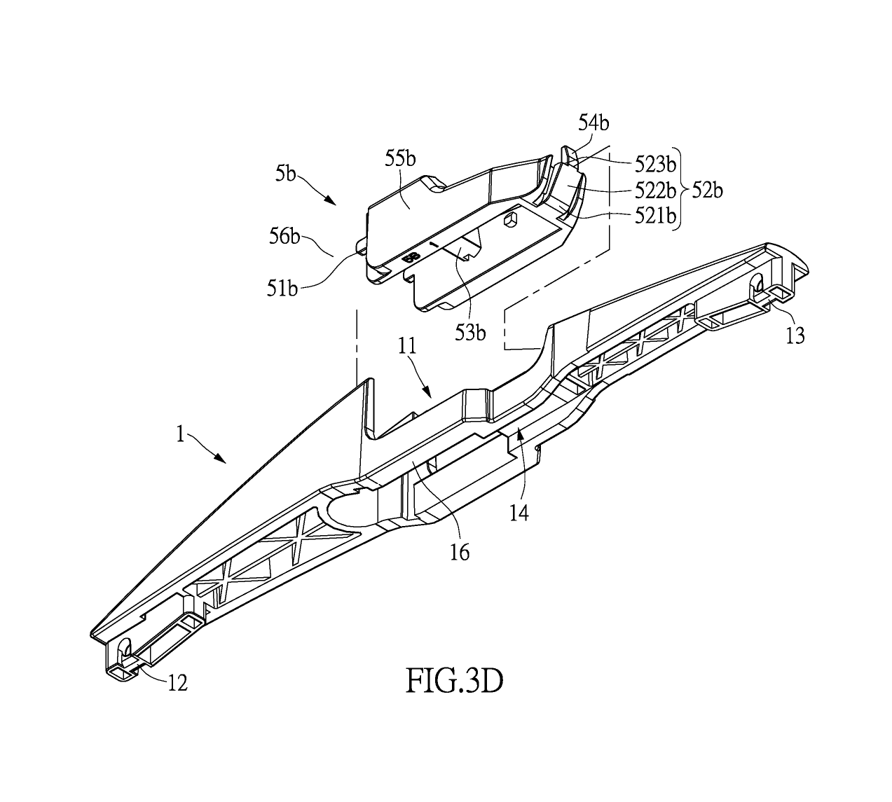

Firstly, referring to FIGS. 3A to 3D, FIG. 3A shows the perspective schematic views of the window wiper mechanism in assembled state of a second embodiment of the present invention, FIG. 3B shows the perspective schematic views of the window wiper mechanism in exploded state of the second embodiment of the present invention, FIG. 3C shows one of the perspective schematic views of the accessory member and the base member in exploded state of the second embodiment of the present invention, and FIG. 3D shows another of the perspective schematic views of the accessory member and the base member in exploded state of the second embodiment of the present invention. Compared to FIG. 3A and FIG. 1A, the second embodiment and the first embodiment have a difference that, the patterns of the accessory member 5b of the second embodiment are distinct from the accessory member 5a of the first embodiment. The accessory member 5b of the second embodiment may be adapted for different models of cars having the window wiper mechanism R.

Specifically, the window wiper mechanism R′ of the second embodiment of the present invention includes a base member 1, a standing member 2, a supporting member 3, a wiper member 4, and an accessory member 5b. More specifically, the base member 1 includes an accommodating groove 11, a first connecting part 12, and a second connecting part 13. Next, the standing member 2 is disposed on the base member 1, and includes a first standing part 21 and a second standing part 22. The first standing part 21 and the second standing part 22 are disposed corresponding to each other. Then, the first standing part 21 has a first bonding part 211, the second standing part 22 has a second bonding part 221, the first bonding part 211 and the first connecting part 12 of the base member 1 are connected with each other, and the second bonding part 221 and the second connecting part 13 of the base member 1 are connected with each other. According to the above, the supporting member 3 is disposed on the standing member 2, and the wiper member 4 is disposed on the supporting member 3, wherein the wiper member 4 is connected to the standing member 2 through the supporting member 3. Besides, the wiper member 4 is disposed on the base member 1 through the standing member 2. It should be stated that, since configurations of the base member 1, the standing member 2, the supporting member 3, and the wiper member 4 of the window wiper mechanism R′ of the second embodiment of the present invention are identical to that of the first embodiment of the present invention, they do not bear repeating herein.

Based on the above description, as shown in FIGS. 3C and 3D, the accessory member 5b is disposed in the accommodating groove 11 of the base member 1, the accessory member 5b has an abutting portion 51b and a fastening portion 52b, the abutting portion 51b abuts against an abutting surface 111 of the base member 1, and the engaging portion 112 and the fastening portion 52b are connected with each other. Specifically, in the second embodiment of the present invention, a bonding force between the accessory member 5b and the base member 1 is increased by changing an area that the abutting portion 51b abuts against the abutting surface 111 of the base member 1. For example, as shown in FIGS. 3C and 3D, the abutting portion 51b of the accessory member 5b may have larger volume and area.

As mentioned above, the fastening portion 52b of the accessory member 5b has a bending end 521b, an inclined plane 522b, and a snap end 523b, and they abut against each other via the snap end 523b and the clasping end 1121 of the accommodating groove 11, such that the fastening portion 52b of the accessory member 5b and the engaging portion 112 of the base member 1 are connected with each other. In addition, the base member 1 further has an accommodating portion 113, and the accessory member 5b further has a denting portion 56b, such that the accessory member 5b can be applied in different models of cars having wiper arms. In specifically, in the second embodiment of the present invention, the accessory member 5b has two abutting portions 51b, and the denting portion 56b is disposed between the two abutting portions 51b. In this way, when the user intends to dispose the accessory member 5b on the base member 1, the abutting portions 51b of the accessory member 5b can be obliquely inserted firstly between the bottom surface 16 and the abutting surface 111 of the base member 1, and the fastening portion 52b is then fastened in the engaging portion 112.

As described above, the abutting portion 51b of the accessory member 5b is used as a pivot shaft, and one end of the abutting portion 51b opposite to the accessory member 5b is then pressed into the accommodating groove 11 of the base member 1, so that the accessory member 5b and the base member 1 are engaged with each other. Specifically, in the embodiment of the present invention, the bending end 521b may have an elastic force, hence, when the accessory member 5b is pressed into the accommodating groove 11 of the base member 1, the inclined plane 522b of the accessory member 5b slides into the accommodating space S of the base member 1 by the elastic force of the bending end 521b. When the inclined plane 522b of the accessory member 5b and the bending end 521b both slide into the accommodating space S of the base member 1, the snap end 523b of the accessory member 5b abuts against the clasping end 1121 of the base member 1. Therefore, the accessory member 5b is stably disposed in the accommodating groove 11 of the base member 1. In detail, the accessory member 5b and the base member 1 are bound together by the snap end 523b and the clasping end 1121 abutting against each other, and the abutting portion 51b and the abutting surface 111 abutting against each other, so that the accessory member 5b is disposed on the base member 1.

After that, the accessory member 5b further includes an end portion 54b which is disposed on the snap end 523b. Thus, the bending end 521b, the inclined plane 522b, and the snap end 523b are moved by the user pressing the end portion 54b of the accessory member 5b. In detailed description, when the user would like to remove the accessory member 5b from the base member 1, the user can press the end portion 54b of the accessory member 5b, so that the end portion 54b is moved toward the abutting portion 51b. Thus, the bending end 521b, the inclined plane 522b, and the snap end 523b are moved away from the accommodating space S of the base member 1 by movement of the end portion 54b, and the snap end 523b of the accessory member 5b and the clasping end 1121 of the base member 1 are separated.

Furthermore, the accessory member 5b has a connecting portion 53b which is disposed between the abutting portion 51b and the fastening portion 52b. In the second embodiment of the present invention, the connecting portion 53b is disposed on the accessory member 5b having a side wall 55b. Specifically, the connecting portion 53b protrudes from the two side walls 55b of the accessory member 5b. It should be noted that, the configuration of the accessory member 5b of the second embodiment is identical to that of the abovementioned embodiment, so it does not bear repeating herein.

The window wiper mechanism R′ of the second embodiment of the present invention can coordinate with the engaging portion 112 of the base member 1 through the fastening portion 52b of the accessory member 5b, such that the user can change various patterns of the accessory members 5b quickly. Additionally, via changing connecting positions of the connecting portion 53b on the accessory member 5b it can be adapted for wiper arms of different cars.

### Third Embodiment

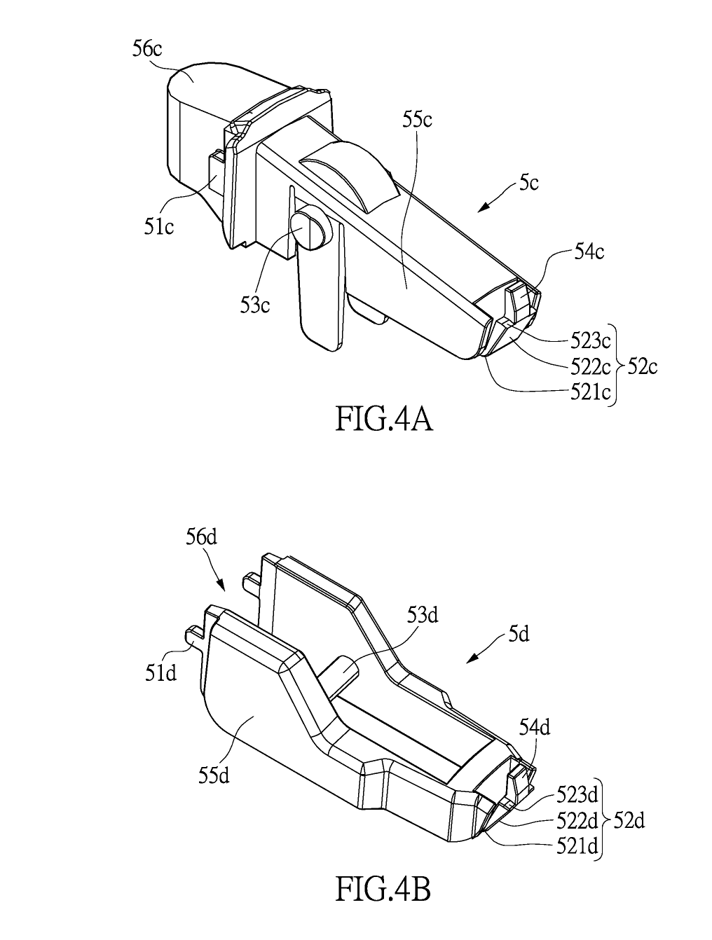

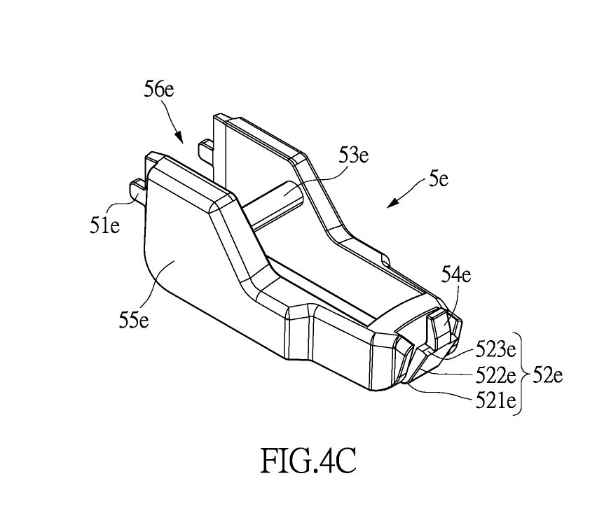

Firstly, please refer to FIG. 4A. FIG. 4A is the perspective schematic view of the accessory member of a third embodiment of the present invention. Compared to FIG. 4A and FIG. 2A, a difference between the third embodiment and the first embodiment is: a pattern of an accessory member 5c of the third embodiment is distinct from the pattern of the accessory member 5a of the first embodiment.

Specifically speaking, the accessory member 5c of the third embodiment has an abutting portion 51c and a fastening portion 52c, the abutting portion 51c abuts against the abutting surface 111 of the base member 1, and the engaging portion 112 and the fastening portion 52c are connected with each other. The fastening portion 52c of the accessory member 5c has a bending end 521c, an inclined plane 522c, and a snap end 523c, and they abut against each other via the snap end 523c and the clasping end 1121 of the accommodating groove 11, such that the snap end 523c of the accessory member 5c and the engaging portion 112 of the base member 1 are connected with each other. In addition, the accessory member 5c further includes an end portion 54c which is disposed on the snap end 523c. Accordingly, when the user presses the end portion 54c of the accessory member 5c, the bending end 521c, the inclined plane 522c, and the snap end 523c are moved by movement of the end portion 54c. The accessory member 5c further has a connecting portion 53c which is disposed between the abutting portion 51c and the fastening portion 52c, and is located between the accessory member 5c having two corresponding side walls 55c. It should be said that, the accessory member 5c of the third embodiment further has a protruding portion 56c, and the accommodating portion 113 of the base member 1 having a shape can correspond to the protruding portion 56c. For instance, the protruding portion 56c may be disposed between the two abutting portions 51c. In this way, when the user would like to dispose the accessory member 5c on the base member 1, the abutting portion 51c of the accessory member 5c can be abutted against the abutting surface 111 of the base member 1 first, and the protruding portion 56c of the accessory member 5c is also abutted and disposed in the accommodating portion 113 of the base member 1.

### Fourth Embodiment

Firstly, please refer to FIG. 4B. FIG. 4B is the perspective schematic view of the accessory member of a forth embodiment of the present invention. Comparing FIG. 4B and FIG. 2A, a difference between the fourth embodiment and the first embodiment is: a pattern of an accessory member 5d of the fourth embodiment is distinct from the pattern of the accessory member 5a of the first embodiment.

Specifically speaking, the accessory member 5d of the fourth embodiment has an abutting portion 51d and a fastening portion 52d, the abutting portion 51d abuts against the abutting surface 111 of the base member 1, and the engaging portion 112 and the fastening portion 52d are connected with each other. The fastening portion 52d of the accessory member 5d has a bending end 521d, an inclined plane 522d, and a snap end 523d, and they abut against each other via the snap end 523d and the clasping end 1121 of the accommodating groove 11 of the base member 1, such that the snap end 523d of the accessory member 5d and the engaging portion 112 of the base member 1 are connected with each other. In addition, the accessory member 5d further includes an end portion 54d which is disposed on the snap end 523d. Accordingly, when the user presses the end portion 54d of the accessory member 5d, the bending end 521d, the inclined plane 522d, and the snap end 523d are moved by movement of the end portion 54d. The accessory member 5d further has a connecting portion 53d which is disposed between the abutting portion 51d and the fastening portion 52d, and is located between the accessory member 5d having two corresponding side walls 55d. It should be said that, the accessory member 5d of the fourth embodiment further has a denting portion 56d, and the accessory member 5d can be applied in different models of cars having wiper arms.

### Fifth Embodiment

Firstly, please refer to FIG. 4C. FIG. 4C is the perspective schematic view of the accessory member of a fifth embodiment of the present invention. Comparing FIG. 4C and FIG. 4B, a difference between the fifth embodiment and the fourth embodiment is: a pattern of an accessory member 5e of the fifth embodiment is distinct from the pattern of the accessory member 5d of the fourth embodiment, and a disposed position of a connecting portion 53e of the accessory member 5e of the fifth embodiment is distinct from a disposed position of the connecting portion 53d of the accessory member 5d of the fourth embodiment.

Specifically, the accessory member 5e of the fifth embodiment has an abutting portion 51e and a fastening portion 52e, the abutting portion 51e abuts against the abutting surface 111 of the base member 1, and the engaging portion 112 and the fastening portion 52e are connected with each other. The fastening portion 52e of the accessory member 5e has a bending end 521e, an inclined plane 522e, and a snap end 523e, and they abut against each other via the snap end 523e and the clasping end 1121 of the accommodating groove 11 of the base member 1, such that the snap end 523e of the accessory member 5e and the engaging portion 112 of the base member 1 are connected with each other. In addition, the accessory member 5e further includes an end portion 54e which is disposed on the snap end 523e. Accordingly, when the user presses the end portion 54e of the accessory member 5e, the bending end 521e, the inclined plane 522e, and the snap end 523e are moved by movement of the end portion 54e. The accessory member 5e further has a connecting portion 53e which is disposed between the abutting portion 51e and the fastening portion 52e, and is located between the accessory member 5e having two corresponding side walls 55e. It should be said that, the accessory member 5e of the fifth embodiment further has a denting portion 56e, and the accessory member 5e can be applied in different models of cars having wiper arms.

### Efficacy of Embodiments

In summary, the present invention having a benefit that, the window wiper mechanism (R, R′) of the embodiments in the present invention can cooperate with the engaging portion 112 of the base member 1 through the fastening portion (52a, 52b, 52c, 52d, 52e) of the accessory member (5a, 5b, 5c, 5d, 5e). Accordingly, when the user presses the end portion (54a, 54b, 54c, 54d, 54e) of the accessory member (5a, 5b, 5c, 5d, 5e), the end portion (54a, 54b, 54c, 54d, 54e) is moved toward to the abutting portion (51a, 51b, 51c, 51d, 51e), and the bending end (521a, 521b, 521c, 521d, 521e), the inclined plane (522a, 522b, 522c, 522d, 522e), and the snap end (523a, 523b, 523c, 523d, 523e) of the accessory member (5a, 5b, 5c, 5d, 5e) are moved away from the accommodating space S of the base member 1 by movement of the end portion (54a, 54b, 54c, 54d, 54e). In this way, the snap end (523a, 523b, 523c, 523d, 523e) of the accessory member (5a, 5b, 5c, 5d, 5e) and the clasping end 1121 of the base member 1 are separated.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A window wiper mechanism, comprising:
a base member including an accommodating groove which has an abutting surface and an engaging portion, and the abutting surface and the engaging portion being disposed corresponding to each other;
a wiper member being disposed on the base member; and
an accessory member being disposed in the accommodating groove and having an abutting portion and a fastening portion, the abutting portion abutting against the abutting surface of the base member, and the engaging portion and the fastening portion are connected with each other.

2. The window wiper mechanism as claimed in claim 1, wherein the engaging portion has a clasping end and an accommodating space corresponding to the fastening portion.

3. The window wiper mechanism as claimed in claim 2, wherein the fastening portion has a bending end, an inclined plane, and a snap end, and the fastening portion connects to the engaging portion via the snap end abutting against the clasping end.

4. The window wiper mechanism as claimed in claim 3, wherein the inclined plane slides into the accommodating space through the bending end.

5. The window wiper mechanism as claimed in claim 3, wherein the accessory member further comprises: an end portion disposed on the snap end, and the base member further comprises: an outer surface, the end portion protruded on the outer surface, and the snap end and the clasping end separated from each other via pressing the end portion.

6. The window wiper mechanism as claimed in claim 1, wherein the accessory member has a connecting portion disposed between the abutting portion and the fastening portion.

7. The window wiper mechanism as claimed in claim 1, wherein the accessory member has two of the abutting portions and a protruding portion, the protruding portion is disposed between the two abutting portions, the base member has an accommodating portion, and the protruding portion is disposed in the accommodating portion.

8. The window wiper mechanism as claimed in claim 1, further comprising: a standing member and a supporting member, the standing member is disposed on the base member, and the supporting member is disposed on the standing member, wherein the base member further comprises: a first connecting part and a second connecting part, and the accommodating groove is disposed between the first connecting part and the second connecting part, wherein the standing member comprises a first standing part and a second standing part, the first standing part and the second standing part are disposed corresponding to each other, the first standing part has a first bonding part, the second standing part has a second bonding part, the first bonding part and the first connecting part are connected with each other, and the second bonding part and the second connecting part are connected with each other, wherein the wiper member is connected to the standing member through the supporting member.

9. The window wiper mechanism as claimed in claim 1, wherein the base member further comprises a dodge groove, the dodge groove and the accommodating groove are disposed corresponding to each other, and the dodge groove and the accommodating groove are disposed at two sides of the base member respectively, wherein the dodge groove has a width larger than the wiper member so as to receive the wiper member.

10. The window wiper mechanism as claimed in claim 1, wherein the base member further comprises: a bottom surface located beneath the base member, and a vertical distance between the bottom surface and the abutting surface is larger than a vertical distance between the bottom surface and the abutting portion.
